(19) United States
(12) Patent Application Publication
(10) Pub. No.: US 2024/0147401 A1
(43) Pub. Date: May 2, 2024

(54) METHOD AND APPARATUS FOR MANAGING ASSOCIATION BETWEEN CLIENT AND MEMBER ACCESS POINT IN MULTI-ACCESS POINT SYSTEM

(71) Applicant: MEDIATEK INC., Hsin-Chu (TW)

(72) Inventors: Chien-Fang Hsu, Hsinchu City (TW); Chih-Chun Kuo, Hsinchu City (TW)

(73) Assignee: MEDIATEK INC., Hsin-Chu (TW)

(21) Appl. No.: 18/376,414

(22) Filed: Oct. 3, 2023

Related U.S. Application Data
(60) Provisional application No. 63/381,141, filed on Oct. 27, 2022.

(51) Int. Cl. H04W 60/00; H04L 5/00

(52) U.S. Cl. CPC H04W 60/005; H04L 5/0053

(57) ABSTRACT

An association management method includes: after coordination association between a client and a plurality of member APs in a multi-access point (MAP) system is successfully completed, generating a request frame to manage association between the client and a member AP in the MAP system. For example, the request frame may be initiated by the client. For another example, the request frame may be initiated by the member AP.

### CROSS REFERENCE TO RELATED APPLICATIONS

This application claims the benefit of U.S. Provisional Application No. 63/381,141, filed on Oct. 27, 2022. The content of the application is incorporated herein by reference.

### BACKGROUND

The present invention relates to wireless communications, and more particularly, to a method and apparatus for managing association between a client and a member access point (AP) in a multi-AP (MAP) system.

In an MAP system, several APs form a coordination group, and can share resources, including service periods, frequency bands, etc., and also allow space reuse. These APs in the MAP system may be regarded as member APs, and can serve associated client(s) at the same time. For example, they can perform joint transmission toward client(s) to improve reliability or throughput. When a client requests association to one member AP of the MAP system, once the association is approved and established, it is by default propagated to other member APs of the same MAP system so that the client can be served by any member AP of the MAP system. After the client is associated with the MAP system, it needs to keep monitoring all APs' statuses, including beacon frames, trigger frames, etc. That also means the power consumption on the client side may increase significantly. For certain scenarios, a client may not need all member APs' service. Thus, there is a need for an innovative association management design to reduce power consumption of the client after the client is associated with an MAP system.

### SUMMARY

One of the objectives of the claimed invention is to provide a method and apparatus for managing association between a client and a member AP in an MAP system.

According to a first aspect of the present invention, an exemplary association management method is disclosed. The exemplary association management method includes: after coordination association between a client and a plurality of member APs in a multi-access point (MAP) system is successfully completed, generating a request frame to manage association between the client and a member AP in the MAP system, and sending the request frame.

According to a second aspect of the present invention, an exemplary wireless communication device is disclosed. The exemplary wireless communication device includes a network interface circuit and a control circuit. The control circuit is arranged to generate a request frame and instruct the network interface circuit to send the request frame after coordination association between a client and a plurality of member APs in a multi-access point (MAP) system is successfully completed, wherein the request frame is configured to manage association between the client and a member AP in the MAP system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating one wireless communication system that supports association management (e.g., association suspension/disablement/pause) according to an embodiment of the present invention.

FIG. 2 is a diagram illustrating one scenario in which the proposed association management scheme can be enabled for power saving according to an embodiment of the present invention.

FIG. 3 is a diagram illustrating another scenario in which the proposed association management scheme can be enabled for power saving according to an embodiment of the present invention.

FIG. 4 is a diagram illustrating another wireless communication system that supports association management (e.g., association resumption) according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

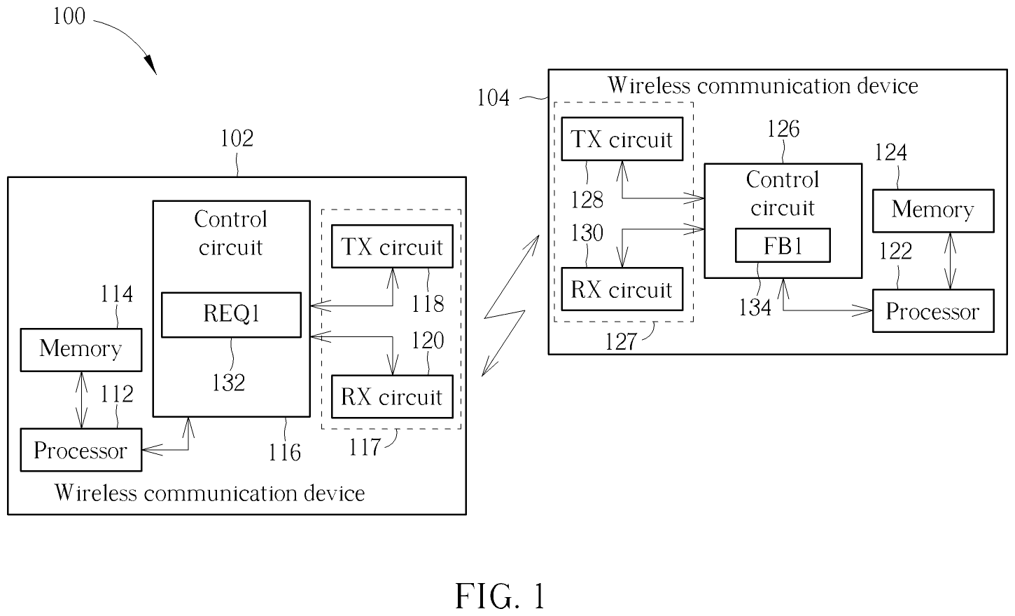

FIG. 1 is a diagram illustrating one wireless communication system that supports association management (e.g., association suspension/disablement/pause) according to an embodiment of the present invention. The wireless communication system 100 includes a plurality of wireless communication devices 102 and 104. For example, the wireless communication system 100 is a Wi-Fi system, including an access point (AP) and a client. In one embodiment of the present invention, the wireless communication device 102 may be an AP, and the wireless communication device 104 may be a client. In another embodiment of the present invention, the wireless communication device 104 may be an AP, and the wireless communication device 102 may be a client. For brevity and simplicity, only two wireless communication devices 102 and 104 are shown in FIG. 1. In practice, the wireless communication system 100 is allowed to have more than two wireless communication devices, including multiple APs and multiple clients. For example, the Wi-Fi system includes an MAP system consisting of a plurality of member APs, one of the wireless communication devices 102 and 104 is a member AP of the MAP system, and the other of the wireless communication devices 102 and 104 is a client that can be associated with the MAP system though coordination association. It should be noted that a member AP of the MAP system may be an AP MLD (multilink device) which owns multiple links working on different RF bands and capable of operating at the same time. For an AP MLD, frame/data exchange with the client can be through one of its affiliated APs. To put it simply, the MAP system that supports the proposed association management scheme may be formed by multiple AP MLDs, multiple non-MLD APs, or a combination thereof. In addition, the client that can be associated with the MAP system may be a non-AP MLD, an STA affiliated with a non-AP MLD, or a non-MLD non-AP STA.

When a client requests association to one member AP of the MAP system, once the association is approved, it is by default propagated to other member APs of the MAP system so that the client can be served by any member AP of the MAP system. The association to the MAP system may be regarded as coordination association. For some function-limited MAP system, the client can still associate each AP independently, and APs exchange/synchronize the client information through the backhaul after receiving the client's association request. The proposed association management scheme may apply to those APs that have association with the client and the synchronized client information.

It should be noted that association is used to indicate the data exchange is possible between two devices and necessary operation parameter and capability exchange between the two devices has been set up and activated (e.g., security key distribution and physical layer (PHY)/medium access control (MAC) operation negotiation), where the two devices may be an AP and a client, an AP MLD and a non-AP MLD, an AP MLD and an STA/client affiliated with a non-AP MLD, or an AP affiliated with an AP MLD and an STA/client affiliated with a non-AP MLD. In the following, the term “AP” may mean a non-MLD AP, an AP MLD, or an AP affiliated with an AP MLD, and the term “client” may mean a non-MLD non-AP STA, a non-AP MLD, or a STA affiliated with a non-AP MLD. Furthermore, the same association behaviors may be described using other proper nouns such as connection, link activation/enablement, communication hook, and cooperation linking. In other words, these terms “association”, “connection”, “link activation/enablement”, “communication hook”, and “cooperation linking” may be interchangeable.

The wireless communication devices 102 and 104 may have the same or similar circuit structure. As shown in FIG. 1, the wireless communication device 102 includes a processor 112, a memory 114, a control circuit 116, and a network interface circuit 117, where the network interface circuit 117 includes a transmitter (TX) circuit 118 and a receiver (RX) circuit 120. The memory 114 is arranged to store a program code. The processor 112 is arranged to load and execute the program code to manage the wireless communication device 102. The control circuit 116 is arranged to control wireless communications with the wireless communication device 104. In a case where the wireless communication device 102 is an AP and the wireless communication device 104 is a client, the control circuit 116 controls the TX circuit 118 of the network interface circuit 117 to deal with downlink (DL) traffic between AP and client, and controls the RX circuit 120 of the network interface circuit 117 to deal with uplink (UL) traffic between AP and client. In another case where the wireless communication device 102 is a client and the wireless communication device 104 is an AP, the control circuit 116 controls the TX circuit 118 of the network interface circuit 117 to deal with UL traffic between AP and client, and controls the RX circuit 120 of the network interface circuit 117 to deal with DL traffic between AP and client.

The wireless communication device 104 includes a processor 122, a memory 124, a control circuit 126, and a network interface circuit 127, where the network interface circuit 127 includes a TX circuit 128 and an RX circuit 130. The memory 124 is arranged to store a program code. The processor 122 is arranged to load and execute the program code to manage the wireless communication device 104. The control circuit 126 is arranged to control wireless communications with the wireless communication device 102. In a case where the wireless communication device 102 is an AP and the wireless communication device 104 is a client, the control circuit 126 controls the TX circuit 128 of the network interface circuit 127 to deal with UL traffic between AP and client, and controls the RX circuit 130 of the network interface circuit 127 to deal with DL traffic between AP and client. In another case where the wireless communication device 102 is a client and the wireless communication device 104 is an AP, the control circuit 126 controls the TX circuit 128 of the network interface circuit 127 to deal with DL traffic between AP and client, and controls the RX circuit 130 of the network interface circuit 127 to deal with UL traffic between AP and client.

It should be noted that only the components pertinent to the present invention are illustrated in FIG. 1. In practice, the wireless communication device 102 may include additional components to achieve designated functions, and/or the wireless communication device 104 may include additional components to achieve designated functions.

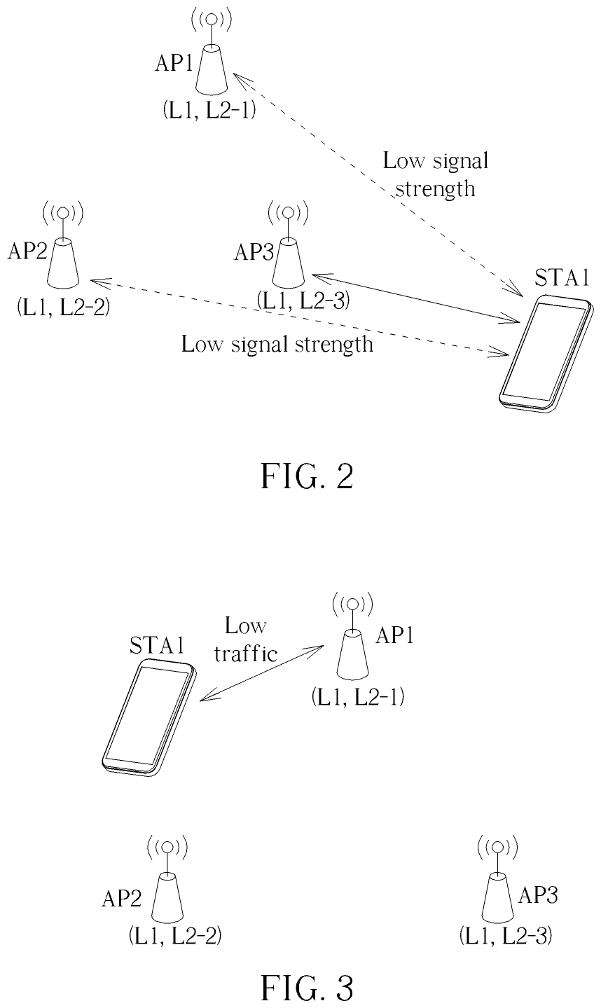

The wireless communication devices 102 and 104 both support the proposed association management scheme, where one of the wireless communication devices 102 and 104 is a client, and the other of the wireless communication devices 102 and 104 is one of the member APs in an MAP system. For certain scenarios, a client does not need all member APs' service. FIG. 2 is a diagram illustrating one scenario in which the proposed association management scheme can be enabled for power saving according to an embodiment of the present invention. Suppose that the MAP system includes three member APs (labeled by AP1, AP2, AP3), and a client (labeled by STA1) is successfully associated with the MAP system. Usually, APs are physically located at different places to enlarge the coverage of the MAP system. As shown in FIG. 2, AP1 and AP2 are not in the proximity of STA1, and signal strength of AP1 and AP2 may not be strong enough to support efficient traffic transmission/receive for STA1. The proposed association management scheme may suspend association between AP1 and STA1 and association between AP2 and STA1. After the association between AP1 and STA1 and association between AP2 and STA1 are suspended, STA1 does not need to monitor statuses of AP1 and AP2, and the power consumption of STA 1 can be effectively reduced. For example, one of the wireless communication devices 102 and 104 may be STA1, and the other of the wireless communication devices 102 and 104 may be one of AP1 and AP2.

FIG. 3 is a diagram illustrating another scenario in which the proposed association management scheme can be enabled for power saving according to an embodiment of the present invention. When the traffic is at a low level, STA1 may not need to have multiple APs' service, and association to a single member AP (e.g., AP1) may be enough. The proposed association management scheme may suspend association between AP2 and STA1 and association between AP3 and STA1. After the association between AP2 and STA1 and association between AP3 and STA1 are suspended, STA1 does not need to monitor statuses of AP2 and AP3, and the power consumption of STA 1 can be effectively reduced. For example, one of the wireless communication devices 102 and 104 may be STA1, and the other of the wireless communication devices 102 and 104 may be one of AP2 and AP3.

To put it simply, the proposed association management scheme can enable association suspension between a member AP and a client to make the client keep necessary association(s) only for saving power and focusing on valid transmission/receive. In addition, it also can help member APs to manage clients requiring less resources, and help efficiency of necessary transmission/receive of urgent traffic.

It should be noted that association suspension between a member AP and a client does not cause deassociation of the client. That is, association between a member AP and a client is suspended under a condition that the client is still associated with the MAP system. The present invention also proposes using another client list, say member AP association client list, to manage clients that can be served by a member AP. As shown in FIG. 2 and FIG. 3, each member AP maintains a client list of the coordination association L1, and the client list of the coordination association L1 is the same as other member APs' client lists of the coordination association L1. The client list of the coordination association L1 needs to be updated when association or deassociation of a client happens. In these examples, an identifier of STAT is recorded in the same client list of the coordination association L1 maintained by all of AP1, AP2, AP3. In addition to the client list of the coordination association L1, each member AP maintains its member AP association client list L2-1/L2-2/L2-3, and the member AP association client list L2-1/L2-2/L2-3 is not necessarily the same as other member APs' member AP association client lists. For example, the member AP association client list L2-1/L2-2/L2-3 of a member AP may be a subset of the client list of the coordination association L1 after association between the member AP and the client(s) is suspended by the proposed association management scheme, and may be the same as the client list of the coordination association L1 after suspended association between the member AP and the client(s) is resumed by the proposed association management scheme. Regarding the example shown in FIG. 2, an identifier of STAT is recorded in all client lists of the coordination association L1 maintained by AP1, AP2, AP3 and is also recorded in the member AP association client list L2-3 maintained by AP2 after the association between AP1 and STAT and association between AP2 and STAT are suspended, and the identifier of STAT is removed from the member AP association client list L2-1 maintained by AP1 and is also removed from the member AP association client list L2-2 maintained by AP2 after the association between AP1 and STAT and association between AP2 and STAT are suspended. Regarding the example shown in FIG. 3, an identifier of STAT is recorded in all client lists of the coordination association L1 maintained by AP1, AP2, AP3 and is also recorded in the member AP association client list L2-1 maintained by AP1 after the association between AP2 and STAT and association between AP3 and STAT are suspended, and the identifier of STAT is removed from the member AP association client list L2-2 maintained by AP2 and is also removed from the member AP association client list L2-3 maintained by AP3 after the association between AP2 and STAT and association between AP3 and STAT are suspended.

The member AP only serves clients on its member AP association client list. The member AP association client list L2-1/L2-2/L2-3 is updated while there is update in the client list of the coordination association L1 when association or deassociation of a client happens. When a new client is associated to the MAP system, an identifier of the new client is added to the client list of the coordination association L1, and is also added to each member AP association client list by default. When a client is deassociated from the MAP system, an identifier of the client is removed from the client list of the coordination association L1, and is removed from a member AP association client list if the identifier of the client is still on the member AP association client list. During a period in which a client is still associated with the MAP system (i.e., an identifier of the client is still on the client list of the coordination association L1), the proposed association management scheme can manage association suspension/resumption between the client and the member AP.

Suppose that the wireless communication device 102 is a client and the wireless communication device 104 is a member AP in the MAP system. In a first association management design, an association management request is initiated by a client. Hence, after coordination association between the wireless communication device (client) 102 and a plurality of member APs in the MAP system is successfully completed, the control circuit 116 of the wireless communication device (client) 102 generates a request frame (labeled by “REQ1”) 132 to manage association with the wireless communication device (member AP) 104 before deassociation of the wireless communication device (client) 102 happens, and instructs the network interface circuit 117 (particularly, TX circuit 118 of network interface circuit 117) to send the request frame 132 from the wireless communication device (client) 102 to any of the member APs in the MAP system. Since member APs in the MAP system can communicate with each other through the backhaul, the request frame 132 generated for managing association with the wireless communication device 104 is not necessarily sent to the wireless communication device (member AP) 104.

The association management between the wireless communication devices 102 and 104 may include association suspension. Hence, when the wireless communication device (client) 102 needs to suspend association with the wireless communication device (member AP) 104 so that it does not need to monitor beacon frames and trigger frames from the wireless communication device (member AP) 104, the wireless communication device (client) 102 generates the request frame 132 that is configured to request association suspension with the wireless communication device (member AP) 104. The member AP to suspend association may be specified in the request frame 132 by a member AP identifier (ID), a member AP MAC address, or other identity.

Negotiation procedures (frame exchange) may be required to define the association suspension and/or when to be effective. For example, management frames (e.g., action frames) may be used to complete the negotiation procedures. In one exemplary design, a two-way negotiation mechanism may be employed. Hence, the wireless communication device (client) 102 generates and sends the request frame 132 to one of the member APs in the MAP system, and the wireless communication device (member AP) 104 responds with a frame (labeled by “FB1”) 134 being a response frame that is generated in response to the request frame 132, where the response frame may indicate whether association suspension requested by the client is accepted or rejected by the member AP. If there is a timing indication in either of the request frame and the response frame to indicate when the association suspension is to be effective, the effective suspension applies accordingly. If none of the request frame and the response frame indicates when the association suspension is to be effective, the suspension may apply immediately after the response frame is sent and received by the wireless communication device (client) 102.

In another exemplary design, one-way notification mechanism may be employed. Hence, the wireless communication device (client) 102 generates and sends the request frame 132 to one of the member APs in the MAP system, and the wireless communication device (member AP) 104 responds with a frame (labeled by “FB1”) 134 being an acknowledgement (ACK) frame that is generated in response to the request frame 132. If there is a timing indication in the request frame to indicate when the association suspension is to be effective, the effective suspension applies accordingly. If the request frame does not indicate when the association suspension is to be effective, the suspension may apply immediately once the ACK frame is sent and received by the wireless communication device (client) 102.

When the association suspension is effective (i.e., association is suspended), the wireless communication device (member AP) 104 shall stop traffic/frame exchange to the wireless communication device (client) 102, including individual addressed frames to the wireless communication device (client) 102, and group-addressed/multi-cast frames to the wireless communication device (client) 102 if the wireless communication device (client) 102 is one of the target audience. Furthermore, other member APs of the MAP system shall stop joint transmission in any form with the wireless communication device (member AP) 104 if the transmission target is the wireless communication device (client) 102 that requests association suspension to the wireless communication device (member AP) 104.

Suppose that the wireless communication device 104 is a client and the wireless communication device 102 is a member AP in the MAP system. In a second association management design, an association management request is initiated by a member AP in the MAP system. Hence, after coordination association between the wireless communication device (client) 104 and a plurality of member APs in the MAP system is successfully completed, the control circuit 116 of the wireless communication device (member AP) 102 generates the request frame 132 to manage association with the wireless communication device (client) 104 before deassociation of the wireless communication device (client) 104 happens, and instructs the network interface circuit 117 (particularly, TX circuit 118 of network interface circuit 117) to send the request frame 132 from the wireless communication device (member AP) 102 to the wireless communication device (client) 104.

The association management between the wireless communication devices 102 and 104 may include association suspension. Hence, the wireless communication device (member AP) 102 generates the request frame 132 that is configured to request association suspension with the wireless communication device (client) 104.

Negotiation procedures (frame exchange) may be required to define the association suspension and/or when to be effective. For example, the request frame 132 may be a broadcast frame sent by the wireless communication device (member AP) 102 to suspend association of one or more clients, including the wireless communication device (client) 104, and the wireless communication device (client) 104 responds with a frame (labeled by “FB1”) 134 that is generated in response to the request frame 132, where the frame 134 may be an ACK frame or may be a response frame that indicates whether association suspension requested by the member AP is accepted or rejected by the client. In addition, the broadcast frame may carry a timing indication to indicate when the association suspension is to be effective. If the request frame does not indicate when the association suspension is to be effective, the suspension may apply immediately after the frame 134 is sent and received by the wireless communication device (member AP) 102.

For another example, the request frame 132 may be an individual addressed frame sent by the wireless communication device (member AP) 102 to suspend association of one client (e.g., the wireless communication device 104), and the wireless communication device (client) 104 responds with a frame (labeled by “FB1”) 134 that is generated in response to the request frame 132, where the frame 134 may be an ACK frame or may be a response frame that indicates whether association suspension requested by the member AP is accepted or rejected by the client. In addition, the individual addressed frame may carry a timing indication to indicate when the association suspension is to be effective. If the request frame does not indicate when the association suspension is to be effective, the suspension may apply immediately after the frame 134 is sent and received by the wireless communication device (member AP) 102.

When there is no rejection of the association suspension from the wireless communication device (client) 104 and the association suspension becomes effective, the wireless communication device (member AP) 102 shall stop traffic/frame exchange to the wireless communication device (client) 104. Furthermore, other member APs of the MAP system shall stop joint transmission in any form with the wireless communication device (member AP) 102 if the transmission target is the wireless communication device (client) 104.

The proposed association management scheme may further include association resumption used to resume the suspended association between a client and a member AP that results from association suspension initiated by the client or the member AP.

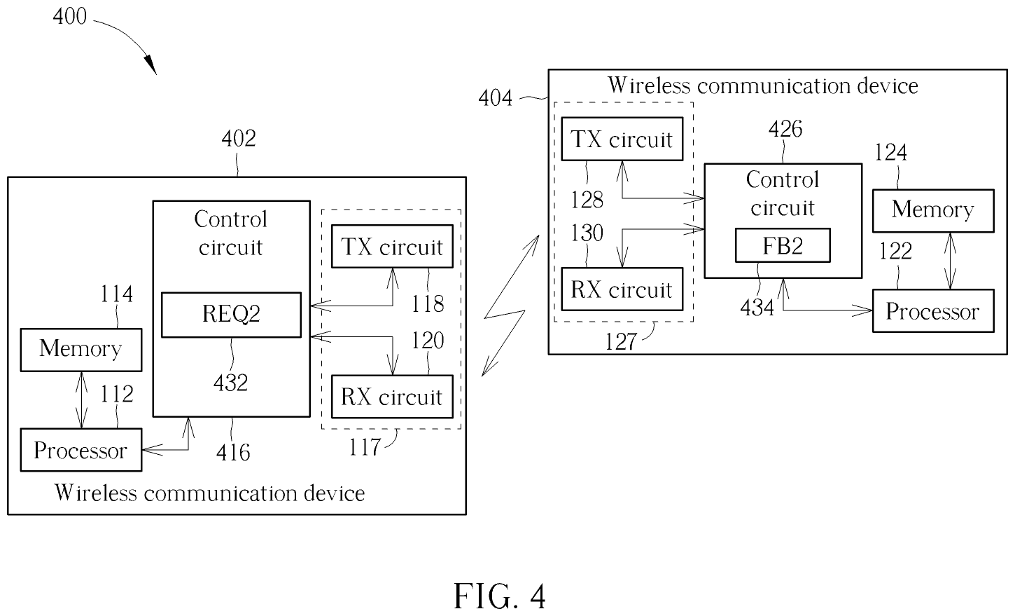

FIG. 4 is a diagram illustrating another wireless communication system that supports association management (e.g., association resumption) according to an embodiment of the present invention. The wireless communication system 400 includes a plurality of wireless communication devices 402 and 404. For example, the wireless communication system 400 is a Wi-Fi system, including an AP and a client. In one embodiment of the present invention, the wireless communication device 402 may be an AP, and the wireless communication device 404 may be a client. In another embodiment of the present invention, the wireless communication device 404 may be an AP, and the wireless communication device 402 may be a client. For brevity and simplicity, only two wireless communication devices 402 and 404 are shown in FIG. 4. In practice, the wireless communication system 400 is allowed to have more than two wireless communication devices, including multiple APs and multiple clients. For example, the Wi-Fi system includes an MAP system consisting of a plurality of member APs, one of the wireless communication devices 402 and 404 is a member AP of the MAP system, and the other of the wireless communication devices 402 and 404 is a client that can be associated with the MAP system through coordination association. As mentioned above, a member AP of the MAP system may be an AP MLD. Hence, the MAP system that supports the proposed association management scheme may be formed by multiple AP MLDs, multiple non-MLD APs, or a combination thereof. In addition, the client that is associated to the MAP system may be a non-AP MLD, a STA affiliated with a non-AP MLD, or a non-MLD non-AP STA.

The wireless communication devices 402 and 404 both support the proposed association management scheme, where one of the wireless communication devices 402 and 404 is a client, and the other of the wireless communication devices 402 and 404 is one of member APs in an MAP system. The major difference between the wireless communication devices 202 and 402 is that the control circuit 416 of the wireless communication device 402 generates a request frame (labeled by “REQ2”) 432 for association management (particularly, association resumption). The major difference between the wireless communication devices 204 and 404 is that the control circuit 426 of the wireless communication device 404 generates a frame (labeled by “FB2”) 434 in response to the request frame 432. In one exemplary implementation, the control circuit 416 of the wireless communication device 402 may further generate the request frame 432 for association suspension between wireless communication devices 402 and 404, and the control circuit 426 of the wireless communication device 404 may further generate the frame 434 in response to the request frame 432. That is, association suspension and association resumption may be initiated by the same wireless communication device. However, this is for illustrative purposes only, and is not meant to be a limitation of the present invention. In another exemplary implementation, the control circuit 426 of the wireless communication device 404 may further generate the request frame 432 for association suspension between wireless communication devices 402 and 404, and the control circuit 416 of the wireless communication device 402 may generate the frame 434 in response to the request frame 432. That is, association suspension and association resumption may be initiated by different wireless communication devices. To put it simply, any wireless communication device that initiates one or both of association suspension and association resumption falls within the scope of the present invention.

It should be noted that only the components pertinent to the present invention are illustrated in FIG. 4. In practice, the wireless communication device 402 may include additional components to achieve designated functions, and/or the wireless communication device 404 may include additional components to achieve designated functions.

Suppose that the wireless communication device 402 is a client and the wireless communication device 404 is a member AP in the MAP system. An association management request may be initiated by the client. Hence, after coordination association between the wireless communication device (client) 402 and a plurality of member APs in the MAP system is successfully completed, the control circuit 416 of the wireless communication device (client) 402 generates the request frame 432 to manage association with the wireless communication device (member AP) 404 before deassociation of the wireless communication device (client) 402 happens, and instructs the network interface circuit 117 (particularly, TX circuit 118 of network interface circuit 117) to send the request frame 432 from the wireless communication device (client) 402 to any of the member APs in the MAP system.

In this embodiment, the association management between the wireless communication devices 402 and 404 may include association resumption. Hence, when the wireless communication device (client) 402 needs to resume the suspended association with the wireless communication device (member AP) 404, the wireless communication device (client) 402 generates the request frame 432 that is configured to request association resumption with the wireless communication device (member AP) 404. As mentioned above, member APs in the MAP system can communicate with each other through the backhaul. Though the association between the wireless communication devices 402 and 404 is suspended, the request frame 432 can be forwarded to the wireless communication device (member AP) 404 through the MAP system. That is, the request frame 432 may be sent to another member AP which is responsible for forwarding the request frame 432 to the wireless communication device (member AP) 404. The member AP to resume association may be specified in the request frame 432 by a member AP ID, a member AP MAC address, or other identity.

Negotiation procedures (frame exchange) may be required to define the association resumption and/or when to be effective. For example, management frames (e.g., action frames) may be used to complete the negotiation procedures. In one exemplary design, a two-way negotiation mechanism may be employed. Hence, the wireless communication device (client) 402 sends the request frame 432 to one of the member APs in the MAP system, and the wireless communication device (member AP) 404 responds with the frame 434 being a response frame that is generated in response to the request frame 432, where the response frame may indicate whether association resumption requested by the client is accepted or rejected by the member AP. If there is a timing indication in either of the request frame and the response frame to indicate when the association resumption is to be effective, the effective resumption applies accordingly. If none of the request frame and the response frame indicates when the association resumption is to be effective, the resumption may apply immediately after the response frame is sent and received by the wireless communication devoice (client) 402.

In another exemplary design, one-way notification mechanism may be employed. Hence, the wireless communication device (client) 402 sends the request frame 432 to one of the member APs in the MAP system, and the wireless communication device (member AP) 404 responds with the frame 434 being an ACK frame that is generated in response to the request frame 432. If there is a timing indication in the request frame to indicate when the association resumption is to be effective, the effective resumption applies accordingly. If the request frame does not indicate when the association resumption is to be effective, the suspension may apply immediately once the ACK frame is sent and received by the wireless communication device (client) 402.

When the association resumption is effective (i.e., the association is resumed), the wireless communication device (member AP) 404 can have traffic/frame exchange with the wireless communication device (client) 402, including individual addressed frames to the wireless communication device (client) 402, and group-addressed/multi-cast frames to the wireless communication device (client) 402 if the wireless communication device (client) 402 is one of the target audience. Furthermore, other member APs of the MAP system can perform joint transmission in any form with the wireless communication device (member AP) 404 toward the wireless communication device (client) 402.

Suppose that the wireless communication device 404 is a client and the wireless communication device 402 is a member AP in the MAP system. An association management request may be initiated by the member AP in the MAP system. Hence, after coordination association between the wireless communication device (client) 404 and a plurality of member APs in the MAP system is successfully completed, the control circuit 416 of the wireless communication device (member AP) 402 generates the request frame 432 to manage association with the wireless communication device (client) 404 before deassociation of the wireless communication device (client) 404 happens, and instructs the network interface circuit 117 (particularly, TX circuit 118 of network interface circuit 117) to send the request frame 432 generated by the wireless communication device (member AP) 402.

The association management between the wireless communication devices 402 and 404 may include association resumption. Hence, the wireless communication device (member AP) 402 generates the request frame 432 that is configured to request association resumption with the wireless communication device (client) 404. Since the association between the wireless communication devices 402 and 404 is suspended, another member AP in the MAP system can help the wireless communication device (member AP) 402 sending the request frame 432 to the wireless communication device (client) 404, where another member AP is associated with the wireless communication device (client) 404, and communicates with the wireless communication device (member AP) 402 through the backhaul.

Negotiation procedures (frame exchange) may be required to define the association resumption and/or when to be effective. For example, the request frame 432 may be a broadcast frame sent by another member AP in the MAP system to resume the suspended association between the wireless communication device (member AP) 402 and one or more clients, including the wireless communication device (client) 404, and the wireless communication device (client) 404 responds with the frame 434 that is generated in response to the request frame 432, where the frame 434 may be an ACK frame or may be a response frame that indicates whether association suspension requested by the member AP is accepted or rejected by the client. In addition, the broadcast frame may carry a timing indication to indicate when the association resumption is to be effective. If the request frame does not indicate when the association resumption is to be effective, the resumption may apply immediately after the frame 434 is sent and received by the wireless communication device (member AP) 402.

For another example, the request frame 432 may be an individual addressed frame sent by another member AP in the MAP system to resume the suspended association between the wireless communication device (member AP) 402 and one client (e.g., the wireless communication device 404), and the wireless communication device (client) 404 responds with the frame 434 that is generated in response to the request frame 432, where the frame 434 may be an ACK frame or may be a response frame that indicates whether association resumption requested by the member AP is accepted or rejected by the client. In addition, the individual addressed frame may carry a timing indication to indicate when the association resumption is to be effective. If the request frame does not indicate when the association resumption is to be effective, the resumption may apply immediately after the frame 434 is sent and received by the wireless communication device (member AP) 402.

When there is no rejection of the association resumption from the wireless communication device (client) 404 and the association resumption becomes effective, the wireless communication device (member AP) 402 can have traffic/frame exchange with the wireless communication device (client) 404. Furthermore, other member APs of the MAP system can perform joint transmission in any form with the wireless communication device (member AP) 402 toward the wireless communication device (client) 404.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An association management method comprising:
after coordination association between a client and a plurality of member APs in a multi-access point (MAP) system is successfully completed:
generating a request frame to manage association between the client and a member AP in the MAP system; and
sending the request frame.

2. The association management method of claim 1, wherein the request frame is generated by the client, and sending the request frame comprises:
sending the request frame to one of the plurality of member APs in the MAP system.

3. The association management method of claim 2, wherein the request frame is configured to request association suspension with the member AP.

4. The association management method of claim 3, wherein the request frame is further configured to carry a timing indication to indicate when the association suspension is to be effective.

5. The association management method of claim 3, further comprising:
receiving a response frame from one of the plurality of member APs, wherein the response frame is generated from the member AP in response to the request frame, and is configured to indicate whether the association suspension is accepted or rejected.

6. The association management method of claim 5, wherein the response frame is further configured to carry a timing indication to indicate when the association suspension is to be effective.

7. The association management method of claim 3, further comprising:
receiving an acknowledgement (ACK) frame from one of the plurality of member APs, wherein the ACK frame is generated from the member AP in response to the request frame.

8. The association management method of claim 2, wherein the request frame is configured to request association resumption with the member AP.

9. The association management method of claim 8, wherein the request frame is further configured to carry a timing indication to indicate when the association resumption is to be effective.

10. The association management method of claim 8, further comprising:
receiving a response frame from one of the plurality of member APs, wherein the response frame is generated from the member AP in response to the request frame, and is configured to indicate whether the association resumption is accepted or rejected.

11. The association management method of claim 10, wherein the response frame is further configured to carry a timing indication to indicate when the association resumption is to be effective.

12. The association management method of claim 8, further comprising:
receiving an acknowledgement (ACK) frame from one of the plurality of member APs, wherein the ACK frame is generated from the member AP in response to the request frame.

13. The association management method of claim 1, wherein the request frame is generated by the member AP, and sending the request frame comprises:
sending the request frame to the client.

14. The association management method of claim 13, wherein the request frame is configured to request association suspension with the client.

15. The association management method of claim 14, wherein the request frame is a broadcast frame or an individual addressed frame.

16. The association management method of claim 14, wherein the request frame is further configured to carry a timing indication to indicate when the association suspension is to be effective.

17. The association management method of claim 13, wherein the request frame is configured to request association resumption with the client, and sending the request frame to the client comprises:
sending the request frame to the client through another member AP in the MAP system, wherein the client is associated with said another member AP.

18. The association management method of claim 17, wherein the request frame is a broadcast frame or an individual addressed frame.

19. The association management method of claim 17, wherein the request frame is further configured to carry a timing indication to indicate when the association resumption is to be effective.

20. A wireless communication device comprising:
a network interface circuit; and
a control circuit, arranged to generate a request frame and instruct the network interface circuit to send the request frame after coordination association between a client and a plurality of member APs in a multi-access point (MAP) system is successfully completed, wherein the request frame is configured to manage association between the client and a member AP in the MAP system.
